(19) United States
(12) Patent Application Publication
(10) Pub. No.: US 2011/0308368 A1
(43) Pub. Date: Dec. 22, 2011

(54) MITER SAW

(75) Inventors: Warren Brown, Victoria (AU); Graham Gerhardt, Victoria (AU); Harry Szommer, Victoria (AU)

(73) Assignee: POSITEC POWER TOOLS (SUZHOU) CO., LTD., Suzhou, Jiangsu (CN)

(21) Appl. No.: 13/140,392

(22) PCT Filed: Dec. 16, 2009
(86) PCT No.: PCT/CN2009/075657

§ 371 Date: Aug. 18, 2011

(30) Foreign Application Priority Data
Dec. 18, 2008 (CN) 200810184983.3
Dec. 19, 2008 (CN) 200810188664.X

(51) Int. Cl. B23D 45/04; B23D 47/04; B23D 45/14

(52) U.S. Cl. 83/468.7; 83/471.3

(57) ABSTRACT

The present invention relates to a miter saw, including a base, a work table, a saw unit pivotally mounted on the base, and fence assembly connected to the base. The fence assembly is directly removably mounted on the base so as not to cause space between the two fences, thus promoting cutting precision and making simple structures at a lower cost. The fences having different heights are interchangeably used, which increases inclined cutting angles.

### CROSS-REFERENCE TO RELATED APPLICATIONS

This is a national phase entry under 35 U.S.C. §371 of International Patent Application PCT/CN2009/075657, filed Dec. 16, 2009, published in Chinese as International Patent Publication WO 2010/069257 A1 on Jun. 24, 2010, which claims the benefit under Article 8 of the Patent Cooperation Treaty to Chinese Patent Application Serial No. 200810184983.3 filed Dec. 18, 2008, and Chinese Patent Application Serial No. 200810188664.X, filed Dec. 19, 2008, the entire disclosure of each of which is hereby incorporated herein by this reference.

### TECHNICAL FIELD

The present invention relates to a miter saw and, more specifically, to a miter saw having a fence assembly.

### BACKGROUND

Currently, the traditional miter saw, as a cutting tool, has been widely used in a variety of cutting applications. Miter saws usually include a base, a working table rotatably mounted on the base, and a saw unit pivotally mounted on the working table. The saw unit includes an angle support mounted on the working table, a motor and a saw blade driven by the motor.

The miter saw includes a fence assembly connected with the base, usually for supporting the workpiece. The fence assembly extends upwardly along the traverse and across the working table. The fence assembly usually includes a fixed fence fixedly mounted on the working table and an auxiliary fence that is movable relative to the fixed fence. The auxiliary fence may be installed in a variety of forms, such as a slidable auxiliary fence that is movable relative to the fixed fence, a pivotal auxiliary fence that is pivotal relative to the fixed fence, and a pin auxiliary fence that can be inserted or pulled out relative to the fixed fence and so on.

U.S. Pat. No. 6,899,005 discloses a miter saw, which includes a fixed fence fixedly interconnected with the base, and a movable fence movably interconnected to the fixed fence, wherein the fixed fence includes a fixed workpiece-supporting surface perpendicular to the working table and the movable fence includes a movable workpiece-supporting surface perpendicular to the working table. The fixed workpiece-supporting surface and the movable workpiece-supporting surface support the workpiece together while cutting. When there is a need to increase the cutting angle, the operator can move the movable fence to avoid other assemblies of the motor or the saw unit interfering with the movable fence for convenience while cutting.

However, there are some defects in conventional fence assemblies. Because both the fixed workpiece-supporting surface and the movable workpiece-supporting surface support the workpiece together, while the movable workpiece-supporting surface needs to slide relative to the fixed workpiece-supporting surface, it is difficult to ensure the vertical alignment of the fixed fence and the movable fence, thus affecting the cutting precision.

Although the workpiece-supporting surface is mainly used for supporting the workpiece to be cut, there is a need for finishing and arranging a fixed fence, thus demanding a bigger base and bigger area for finishing, which leads to higher costs.

### DISCLOSURE

The subject invention provides a miter saw having a fence assembly that can increase inclined cutting angles and provide a supporting surface that has more precision for the workpiece.

The subject invention provides a miter saw having a small base and a low cost.

In one embodiment of the invention, a miter saw for cutting a workpiece comprises a base having a supporting surface for supporting the workpiece; a turntable pivotally mounted on the base; a saw unit pivotally connected to the base, the saw unit comprising a motor and a saw blade rotary driven by the motor; a first fence having a first configuration, the first fence having a first stopping surface that is perpendicular to the supporting surface; a second fence having a second configuration, the second fence having a second stopping surface that is perpendicular to the supporting surface; wherein the first fence and the second fence are selectably and detachably mounted on the base, and the first configuration is different from the second configuration.

In one embodiment, the first configuration has a first height that is the largest distance that the first stopping surface extends upwardly from the supporting surface, and the second configuration has a second height that is the largest distance that the second stopping surface extends upwardly from the supporting surface, and wherein the first height is not equal to the second height.

In a further embodiment, the first fence and the second fence mounted on the base are interchangeable with each other.

In another embodiment, the base has two opposite sides relative to the saw blade.

In one embodiment, the first fence or second fence is mounted on one side of the base.

In one embodiment, the second fence or first fence is mounted on the other side of the base.

In one embodiment, the miter saw has two first fences, respectively mounted on the two opposite sides.

In one embodiment, the miter saw has two second fences, respectively mounted on the two opposite sides.

In one embodiment, a guiding device is disposed between the base and at least one of the first fence has and the second fence, and the guiding device comprises at least one guiding member mounted on the at least one of the first and second fences and a guiding groove mounted on the base, wherein the guiding members are slidably disposed in the guiding groove.

In one embodiment, a locking device is disposed between the base and at least one of the first fence and the second fence. The locking device comprises a screw extending through the at least one guiding member and the at least one of the first and second fences to engage with a nut.

In one embodiment, a positioning device is mounted on at least one of the first and second fences for supporting the workpiece. The positioning device comprises a body and a positioning plate attached on one end of the body. The body is movably mounted on at least one of the first fence and the second fence, and the positioning plate and the first fence assembly support the workpiece together.

In one embodiment, the positioning device comprises a storage position and a work position. In the work position, the body is parallel with the supporting surface; and in the storage position, the body is perpendicular to the supporting surface.

In one embodiment, an opening is displaced on at least one of the first and second stopping surfaces.

In one embodiment, a miter saw for cutting the workpiece comprises a base having a supporting surface for supporting a workpiece; a turntable pivotally mounted on the base; a saw pivotally connected to the base, the saw unit comprising a motor and a saw blade rotary driven by the motor; a first fence assembly connected to the base, the first fence assembly comprising a first fence that has a first stopping surface that is perpendicular to the supporting surface, the first stopping surface having a first height that is the largest distance that the first stopping surface extends upwardly from the supporting surface; wherein the base comprises a mounting surface for engaging the first fence, the mounting surface and the stopping surface being angularly disposed.

In a further embodiment, the angle of the first fence and the mounting surface is 90 degrees.

In one embodiment, the miter saw further comprises a second fence that is interchangeable with the first fence.

In one embodiment, the second fence has a second stopping surface that is perpendicular to the supporting surface. The second stopping surface may have a second height that is the largest distance that the second stopping surface extends upwardly from the supporting surface. The second height may not be equal to the first height.

In one embodiment, a guiding device is disposed between the base and the first fence. The guiding device comprises a guiding member mounted on the first fence and a guiding groove mounted on the base, the guiding member being slidably disposed in the guiding groove.

In one embodiment, a positioning device is mounted on the first fence for supporting the workpiece. The positioning device comprises a body and a positioning plate attached on one end of the body. The body is movably mounted on the first fence assembly, and the positioning plate and the first fence support the workpiece together.

In one embodiment, an opening is displaced on at least one of the first and second stopping surfaces.

In comparison with prior art, the advantages of the present invention are that the base has a mounting surface to cooperate with the fence, and the mounting surface and workpiece supporting surface are angularly disposed so that the fence does not need to be directly mounted on the workpiece supporting surface. This reduces the area of finish surface and the cost. The base can be small and fences having different heights can be disassembled from the base, thus avoiding the drawbacks of the difficult alignment of the fixed fence and movable fence and the misalignment in the upright direction. This promotes cutting precision and makes simpler structures and lower costs. Since the fences have different heights and are interchangeably used, the number of available inclined cutting angles is increased.

### BRIEF DESCRIPTION OF THE DRAWINGS

The present invention is further detailed in combination with the drawings attached and the embodiments described hereinafter, wherein:

FIG. 1 depicts the miter saw having a first fence according to the present invention.

FIG. 2 illustrates a disassembled view of the miter saw according to the present invention.

FIG. 3 is the disassembled view of the miter saw according to the present invention.

FIG. 4 is the disassembled view of the miter saw according to the present invention.

FIG. 5 depicts the miter saw having a second fence according to the present invention.

FIG. 6 is the disassembled view of the miter saw according to the present invention.

FIG. 7 depicts the miter saw having a positioning device according to the present invention.

FIG. 8 illustrates the miter saw having a positioning device according to the present invention.

### DETAILED DESCRIPTION

The present invention will be described in more detail herein with reference to the figures and embodiments.

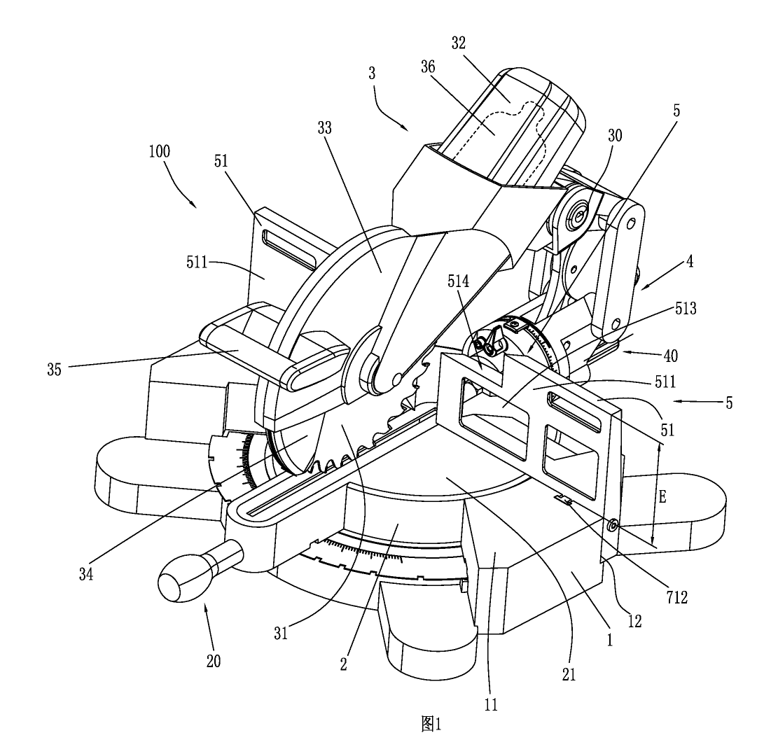

Referring to FIG. 1, a miter saw includes a base 1, a working table 2 rotatably mounted on the base 1, a supporting frame 4 connected to the working table 2, and a saw unit 3 connected to the supporting frame 4. The saw unit 3 is pivotally connected to the supporting frame 4 by a pivotal axis 30 so that the saw unit 3 can be pivoted up and down relative to the base 1 to cut the workpiece.

The working table 2 is movably mounted on the base 1, and a locking mechanism 20 is arranged between the working table 2 and the base 1 for locking the working table 2 on the base 1. The working table 2 includes the working surface 21 for supporting the workpiece.

The saw unit 3 includes a saw blade 31, a motor 36 for driving the saw blade 31 to rotate (the dotted line shows a part of the motor in the figures), a fixed protective cover 33 and a movable protective cover 34, and a handle 35 for driving the saw unit 3 to pivotally rotate by the pivotal axis 30, wherein the motor 36 is rotatably mounted in the motor casing 32. The handle 35 is fixedly mounted on the fixed protective cover 33, and is used by the operator to cut the workpiece by holding the saw unit 3, and a switch is mounted on the handle 35 to start and close the motor 36. The fixed protective cover 33 is generally fixed to the motor casing 32 for covering a part of the saw blade 31. The movable protective cover 34 is pivotally mounted on the fixed protective cover 33 for covering a part of the saw blade 31 in a non-cutting position. A movable cover driven mechanism (not shown in the Figures) is connected to the movable protective cover 34 for opening and closing the movable cover 34 quickly. The fixed protective cover 33 is connected to the support 4 via a pivot 30. The handle 35 can be operated to make the saw unit 3 perform cutting operations.

The base 1 includes a workpiece-supporting surface 11 for supporting the workpiece, and a right and a left side relative to the saw blade 31, the front side being close to the operator and a corresponding back side. The workpiece-supporting surface 11 and the working surface 21 are generally in the same plane and support the workpiece to be cut together.

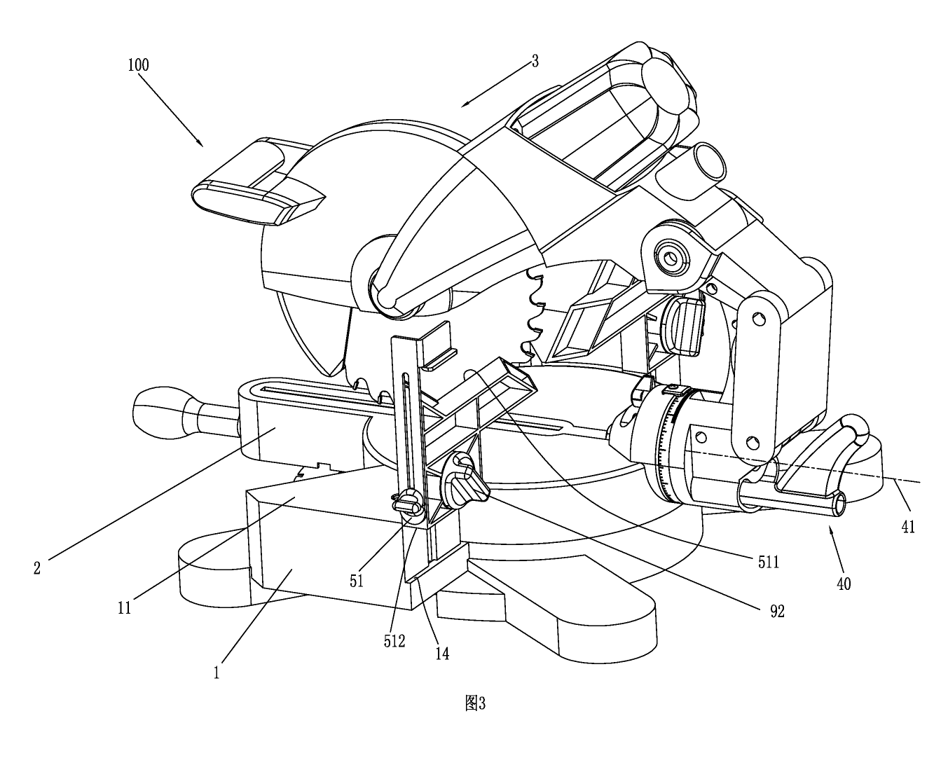

The support 4 is pivotally connected to the working table 2 via a longitudinal axis 41 (as shown in FIG. 3), thus the support 4 and the saw unit 3 are pivotable clockwise and counterclockwise with the longitudinal axis 41 inclining to a determined angle relative to the working table 2 to cut the workpiece, that is, the support 4 and the saw unit 3 incline to the right and left for double-swing cutting. A lock mechanism 40 disposed between the support 4 and the work table 2 locks the support 4 on the work table 2.

The miter saw 100 further includes a first fence assembly 5 that includes a pair of first fences 51 mounted on the right and left sides of the base 1. The two first fences 51 in the same plane are respectively across the work table 2, and support the workpiece together. The first fences 51 may be connected together or be set independently. In this embodiment, a pair of the first fences is set independently and relatively independent of the individual. The specific structure of the first fences 51 and its connection with the base 1 will be described by illustrating one of the first fences 51.

The first fence 51 comprises a first stopping surface 511 that is perpendicular to the workpiece-supporting surface 11 for supporting the workpiece to be cut. The first stopping surface 511 has a first height E, which is the largest distance, where the first stopping surface extends upwardly from the workpiece-supporting surface 11. The first height E equals the distance between the highest point of the first fence 51 and the workpiece-supporting surface 11.

The first fence 51 has a first configuration that may include construction, shape, and size and so on, wherein the size means the length, height and width of the first fence 51 or the area of the first stopping surface 511, and the shape means the first fence 51 may be rectangular, oval, trapezoidal and so on, then the construction means the first fence 51 has openings or protrusions and so on.

In this embodiment, the first fence 51 is roughly rectangular and has at least one opening 513 and step 514. As the first stopping surface 511 is the finish surface, it can reduce the area of the finish surface by arranging opening 513 on the surface, thereby reducing costs, and the structure is easier to make.

When cutting the anomalous workpiece, the workpiece can get through the opening 513, thereby giving the workpiece to be cut a better stopping surface.

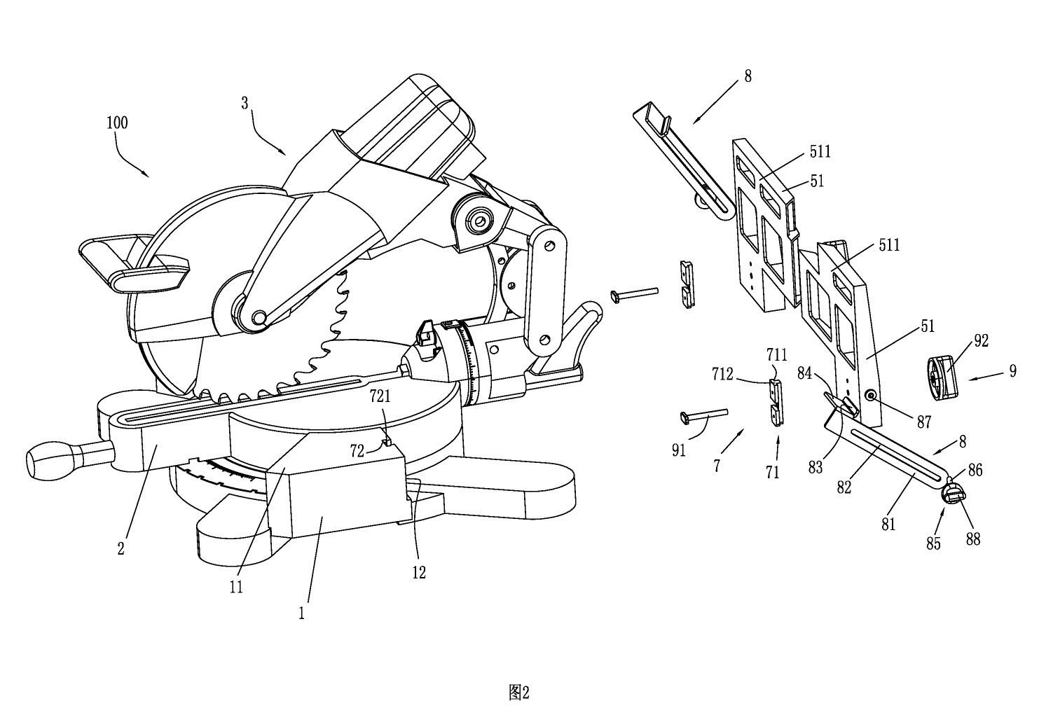

The first fence 51 is releasably mounted on the base 1. Referring to FIG. 2, the base 1 has a first mounting surface 12 (only shows the side of the mounting surface) that cooperates with the first fence 51. The first mounting surface 12 is disposed parallel to the first stopping surface 511 and at the back side of the workpiece-supporting surface 11 to a determined angle relative to the workpiece-supporting surface 11 on the base 1.

In this embodiment, the first mounting surface 12 is disposed at an angle of 90° to the workpiece-supporting surface 11. The first mounting surface 12 and the first stopping surface 511 are fit completely (as shown in FIG. 1), while the first fence 51 is mounted on the base 1.

A guiding device 7 and a locking device 9 are located between the first fence 51 and the base 1. In this embodiment, the guiding device 7 comprises a guiding member 71 mounted on the first fence 51, a guiding groove 72 mounted on the base 1, and the guiding members 71 are slidably received into the guiding groove 72.

The guiding member 71 and the first fence 51 are assembled together by a locking unit (not shown). Of course, the guiding member 71 and the first fence 51 can be integrated.

The guiding member 71 is a T-shaped member having an upper surface 712 and a stopping surface 711, which the guiding groove 72 is leaned on. The guiding groove 72 is a T-shaped groove having a blocking surface 721 contacted with the stopping surface 711, and the guiding members 71 are slidably received into the guiding groove 72. Of course, as is well-known by the person skilled in the art, the guiding groove 72 and guiding member may be other shapes like swallow-tailed groove, V-groove, etc.

Referring to FIG. 3, a blocking surface 14 is disposed on the base 1 for supporting the first fence 51. The blocking surface 14 is disposed parallel to the workpiece-supporting surface 11 and perpendicular to the first mounting surface 12. First fence 51 has a down surface 512 cooperating with the blocking surface 14, and the down surface 512 is disposed perpendicular to the first stopping surface 511.

The locking device 9 has a screw 91 and an engaged nut 92, the screw 91 extending through the holes of guiding member 71 and the first fence 51, then engages with the nut 92, thus locking the first fence 51 on the base 1.

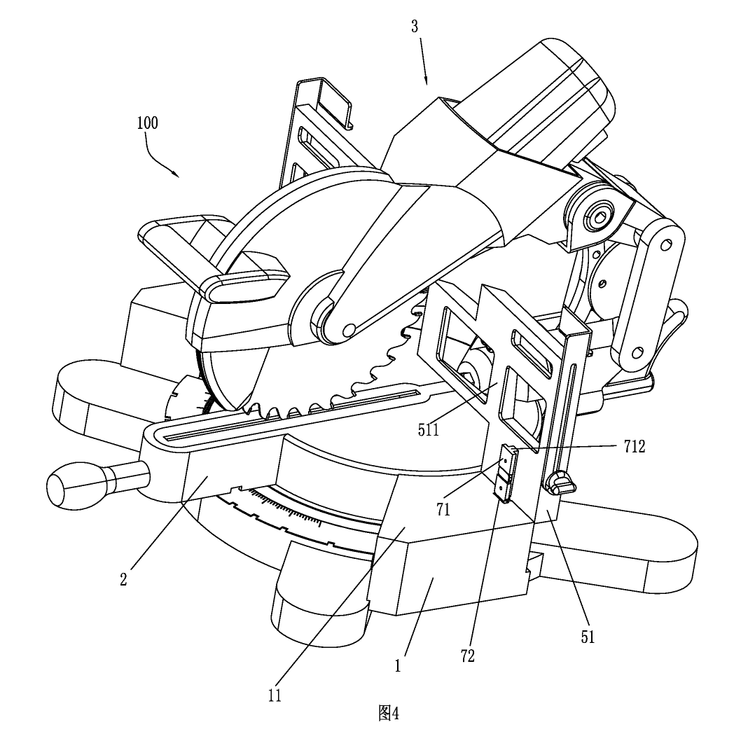

Referring to FIG. 4, when the first fence 51 needs to be assembled, simply insert the guiding member 71 into the guiding groove 72, then slide down until the down surface 512 of the first fence 51 is blocked by the blocking surface 14 of the base 1, and then tighten the nut 92 so that the stopping surface 711 of the guiding member 71 contacts the blocking surface 721 of the guiding groove 72. In this way, the first fence 51 is fixed at one side of the base 1 for locating the workpiece to be cut, while the upper surface 712 of the guiding member 71 is approximately parallel to the workpiece-supporting surface 11 (as shown in FIG. 1). First fence 51 can be directly mounted on the base 1, and since there is only one fence position, it will not cause space as fixed or movable fences, and affect the cutting precision.

When removal of the first fence 51 is desired, just loosen the nut 92, making space between the supporting surface 711 of the guide member and the blocking surface 721 of the guiding groove 72, and then easily remove the first fence 51 by sliding it up.

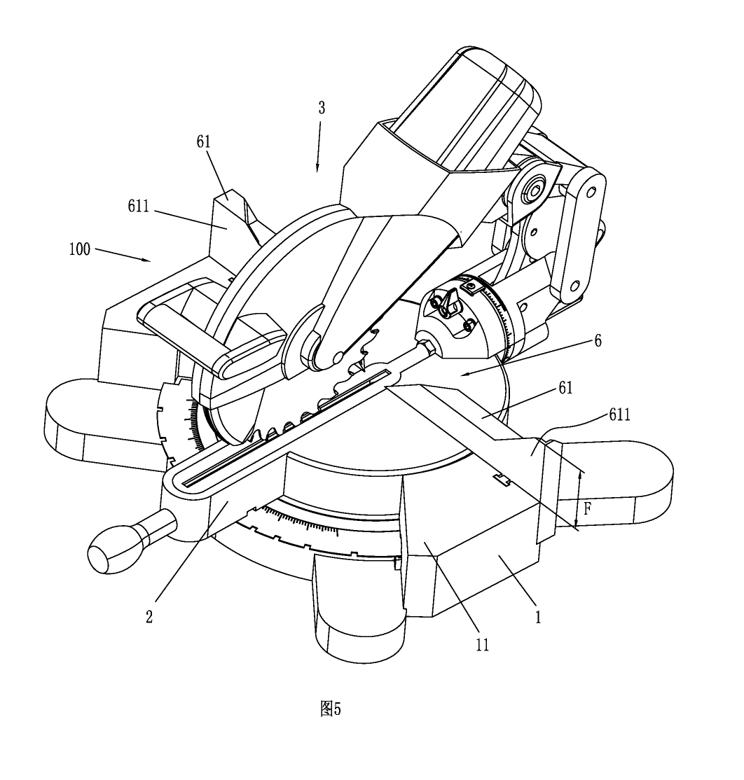

Referring to FIG. 5, the miter saw 100 further includes a second fence assembly 6 having a pair of second fences 61 mounted on the right and left sides of the base 1, and the two second fences 61 in the same plane are respectively across the work table 2 and support the workpiece together. The second fences 61 may be connected together or be set independently. In this embodiment, a pair of the second fences 61 is set independently and relatively independent of the individual as the first fence 51.

The second fence 61 comprises a second stopping surface 611 that is perpendicular to the supporting surface 11 for supporting the workpiece to be cut. The second stopping surface 611 has a second height F, which is largest distance, where the second stopping surface 611 extends upwardly from the supporting surface 11. The second height F equals the distance between the highest point of the second fence 61 and the supporting surface 11. Second height F is less than the first height E, that is, the height of the second fence 61 is less than the height of the first fence 51. In this way, the second fence assembly 6 is suitable for supporting the lower workpiece or the workpiece that needs a larger angle, and the first fence assembly 5 is suitable for supporting the higher workpiece or the workpiece that needs a smaller angle.

The second fence 61 has a second configuration that may include construction, shape, and size and so on, wherein the “size” means the length, height and width of the second fence 61 or the area of the second stopping surface 611, the “shape” means the second fence 61 may be rectangular, oval, trapezoidal and so on, the “construction” means the second fence 61 has openings or protrusions and so on. The first configuration is different from the second configuration. In this embodiment, the two configurations mainly have differences in height.

Of course, as is well-known by the person skilled in the art, they may have the same height, different lengths or widths, or different shapes such as rectangle or trapezoid, or with or without openings and so on.

We can arrange some openings on the second supporting surface 611 of the second fence 61 to reduce the area of the finish surface or make the workpiece to get through. In this embodiment, there is no opening on the second fence 61.

When the second fence 61 is mounted on the base 1, the second stopping surface 611 and the mounting surface 12 of the base 1 are fit completely.

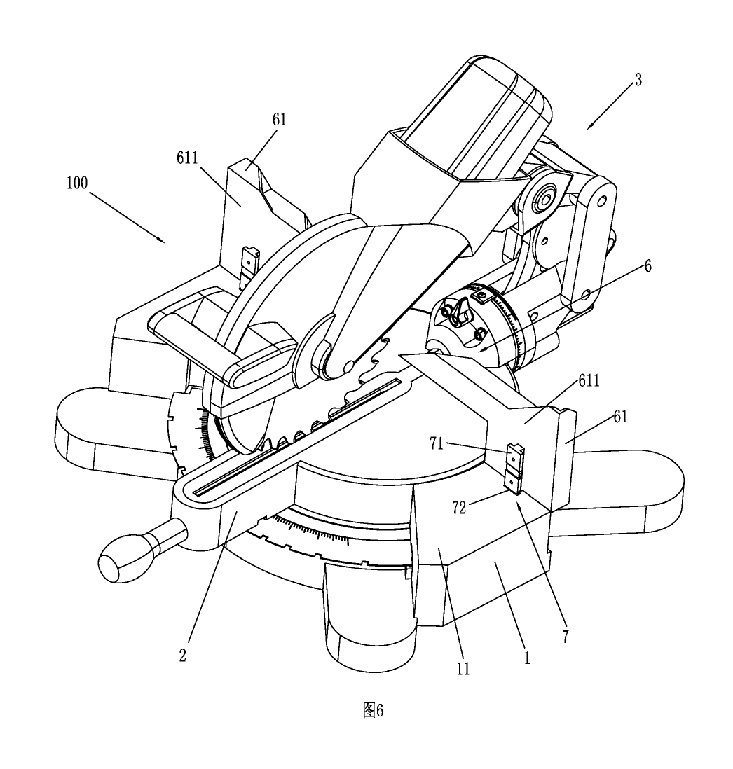

Referring to FIG. 6, a guiding device 7 and a locking device 9, which have the same structure as the devices between the first fence assembly 5 and the base 1 (not shown in the figures), are located between the second fence assembly 6 and the base 1. The second fence assembly 6 is also removably mounted at two sides of the base 1 for locating the workpiece to be cut.

As the first fence assembly 5 and the second fence assembly 6 can be mounted on or dismounted from the base 1, the first fence assembly 5 and the second fence assembly 6 can be selected to be mounted on the base 1 according to the practical situation for supporting the workpiece.

Referring to FIG. 5, when the operator needs to cut the lower workpiece or a larger angle workpiece, they can mount the second fence assembly 6 on the base 1 according to the above-mentioned method. Referring to FIG. 1, when cutting the higher workpiece or a smaller angle workpiece, the operator can dismount the second fence assembly 6 from the base 1 according to the above-mentioned method, then mount the first fence assembly 5. In this way, the operator can choose the suitable fence assembly according to the practical situation for supporting the workpiece, thereby increasing the cutting angle and providing a more precise supporting surface.

Of course, if the operator does not need to incline to the right to cut the workpiece but instead needs to incline to the left to cut the workpiece, he can mount the first fence 51, for example, the higher fence on the right side of the base 1 during use. As needed, the operator can choose one of the second fence 62 and the first fence 51 to mount on the left side of the base 1. Similarly, the operator can mount the first fence 51, i.e., the higher fence, on the left side of the base 1 and, as needed, the operator can choose one of the second fence 62 and the first fence 51 to mount on the right side of the base 1.

Of course, as the second fence 61 and the first fence 51 are relatively independent, the first fence 51 and the second fence 61, having two different heights, can be constituted into one new fence assembly. When it is desired to incline to the right to cut the larger angle workpiece, the lower second fence 62 can be mounted at the right side while the higher first fence 51 is mounted at the left side, and vice versa.

As shown in FIGS. 2, 3, 7, and 8, a positioning device 8 is located on the first fence 51 for the operator to cut the crown molding 200. Of course, the positioning device 8 also applies to the second fence assembly 6.

It sets one of the positioning devices 8 on the first fence 51 as an example. As shown in FIG. 2, the positioning devices 8 include a body 81 of a long groove 82, a connecting plate 84 disposed at one side of the body 81, and a positioning plate 83 connected to the connecting plate 84, which is perpendicular to the body 81, and the positioning plate 83 is perpendicular to connecting plate 84. The positioning plate 83 and the first fence 51 are used for positioning the crown molding 200 together.

A fixing device 85 is disposed between the positioning device 8 and the first fence 51, the fixing device 85 being mounted at the other side of the body 81 for fixing the body on the first fence 51, and the fixing device 85 may slide relative to the long groove 82.

The fixing device 85 includes a screw 86 and a threaded hole 87 engaged with the screw 86, the hole 87 being disposed on the first fence 51, and the screw 86 can slide relative to the long groove 82, which includes a knob 88.

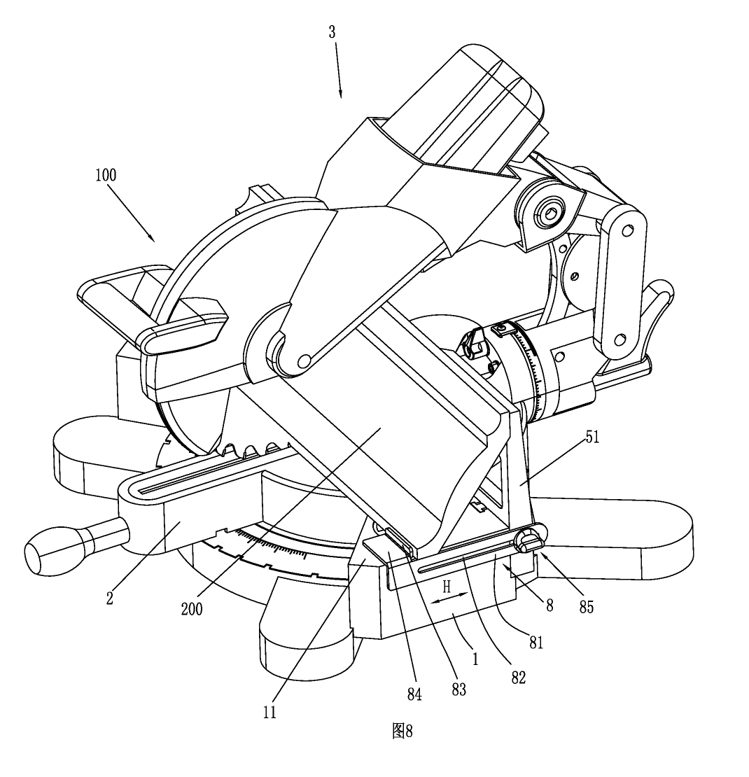

The positioning device 8 has a storage position and work position. As shown in FIG. 8, at its work position, the body 81 of the positioning devices 8 is parallel to the supporting surface 11. The positioning devices 8 and the first fence 51 support the crown molding 200 together. As shown in FIG. 3, at its storage position, i.e., when using the positioning devices 8 is not needed, the body 81 is perpendicular to the supporting surface 11, thus, not affecting the first fence 51 for supporting the workpiece, which is not a crown molding.

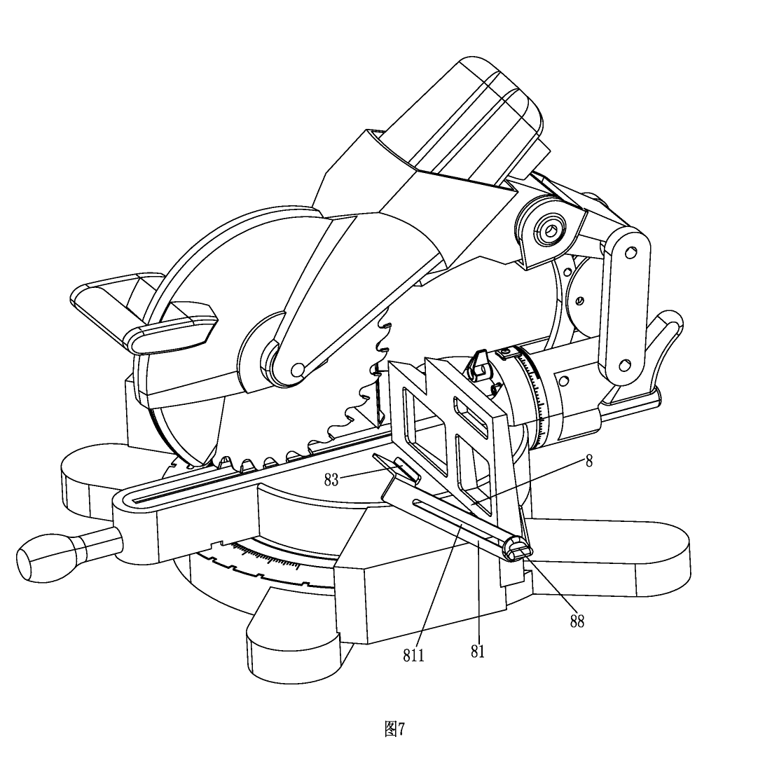

As shown in FIG. 7, when crown molding 200 needs to be cut, first loosen the knob 88 so that it can make the body 81 of the positioning devices 8 pivot around the screw 86 until the down surface of the connecting plate 84 and the supporting surface 11 fit together. As shown in FIG. 8, tightening the knob 88 so that the positioning device 8 is fixed on the first fence 51, and together with the first fence assembly 5, support the crown molding 200.

Of course, the crown molding 200 has different sizes, as shown in FIG. 8, and in order to facilitate position, loosen the knob 88 and adjust the body 81. Then the body 81 slides in the long groove 82 along the direction of H as shown in FIG. 8 until it arrives at the desired position, then tightening the knob 88.

1. A miter saw for cutting a workpiece, comprising:
a base having a supporting surface for supporting a workpiece;
a turntable pivotally mounted on the base;
a saw unit pivotally connected to the base, the saw unit comprising a motor and a saw driven by the motor;
a first fence having a first configuration, the first fence having a first stopping surface that is perpendicular to the supporting surface;
a second fence having a second configuration, the second fence having a second stopping surface that is perpendicular to the supporting surface;
wherein the first fence and the second fence are selectably and detachably mountable on the base, and the first configuration is different from the second configuration.

2. The miter saw according to claim 1, wherein the first configuration has a first height that is the largest distance that the first stopping surface extends upwardly from the supporting surface, and the second configuration has a second height that is the largest distance that the second stopping surface extends upwardly from the supporting surface, and wherein the first height is not equal to the second height.

3. The miter saw according to claim 2, wherein the first fence and the second fence mountable on the base are interchangeable with each other.

4. The miter saw according to claim 1, wherein the base has two opposite sides relative to the saw blade.

5. The miter saw according to claim 4, wherein the first fence or second fence is mountable on one side of the base.

6. The miter saw according to claim 5, wherein the second fence or first fence is mountable on the other side of the base.

7. The miter saw according to claim 4, wherein the miter saw has two first fences that respectively mount on the two opposite sides.

8. The miter saw according to claim 7, wherein the miter saw has two second fences that respectively mount on the two opposite sides.

9. The miter saw according to claim 1, further comprising a guiding device disposed between the base and at least one of the first fence and the second fence, the guiding device comprising at least one guiding member mounted on the at least one of the first and second fence and a guiding groove mounted on the base, wherein the at least one guiding member is slidably disposed in the guiding groove.

10. The miter saw according to claim 9, further comprising a locking device disposed between the base and at least one of the first fence and the second fence, wherein the locking device comprises a screw extending through the at least one guiding member and the at least one of the first and second fences to engage with a nut.

11. The miter saw according to claim 1, further comprising a positioning device mounted on at least one of the first and second fences for supporting the workpiece, the positioning device comprising a body and a positioning plate attached on one end of the body, wherein the body is movably mounted on at least one of the first fence and the second fence, and wherein the positioning plate and the first fence support the workpiece together.

12. The miter saw according to claim 11, wherein the positioning device comprises a storage position and a work position, the work position comprising a position wherein the body is parallel with the supporting surface, and in the storage position comprising a position wherein the body is perpendicular to the supporting surface.

13. The miter saw according to claim 1, wherein an opening is in at least one of the first and second stopping surfaces.

14. A miter saw for cutting a workpiece, comprising:
a base having a supporting surface for supporting a workpiece;
a turntable pivotally mounted on the base;
a saw pivotally connected to the base, the saw unit comprising a motor and a saw driven by the motor;
a first fence assembly connected to the base, the first fence assembly comprising a first fence that has a first stopping surface perpendicular to the supporting surface, the first stopping surface having a first height that is the largest distance where that the first stopping surface extends upwardly from the supporting surface;
wherein the base comprises a mounting surface for engaging the first fence, the mounting surface and the stopping surface being angularly disposed.

15. The miter saw according to claim 14, wherein the angle between the first fence and the mounting surface is 90 degrees.

16. The miter saw according to claim 14, further comprising a second fence that is interchangeable with the first fence.

17. The miter saw according to claim 16, wherein the second fence has a second stopping surface perpendicular to the supporting surface, the second stopping surface having a second height that is the largest distance that the second stopping surface extends upwardly from the supporting surface, and wherein the second height is not equal to the first height.

18. The miter saw according to claim 14, further comprising a guiding device disposed between the base and the first fence, the guiding device comprising a guiding member mounted on the first fence and a guiding groove mounted on the base, wherein the guiding member is slidably disposed in the guiding groove.

19. The miter saw according to claim 14, further comprising a positioning device mounted on at least one of the first fence for supporting the workpiece, the positioning device comprising a body and a positioning plate attached on one end of the body, wherein the body is movably mounted on the first fence assembly, and wherein the positioning plate and the first fence support the workpiece together.

20. A miter saw for cutting a workpiece, comprising:
a base having a supporting surface for supporting a workpiece;
a first fence having a first configuration, the first fence having a first stopping surface that is perpendicular to the supporting surface; and
a second fence having a second configuration, the second fence having a second stopping surface that is perpendicular to the supporting surface,
the first fence and the second fence selectably and detachably mountable on the base, and the first configuration different from the second configuration.
